(19) United States
(12) Patent Application Publication
(10) Pub. No.: US 2014/0110406 A1
(43) Pub. Date: Apr. 24, 2014

(54) SELF-BASTING LID

(71) Applicant: NAMBE, LLC, Sante Fe, NM (US)

(72) Inventors: Robert Varakian, Closter, NJ (US); Neil Cohen, New York, NY (US)

(73) Assignee: NAMBE, LLC, Sante Fe, NM (US)

(21) Appl. No.: 13/655,746

(22) Filed: Oct. 19, 2012

(51) Int. Cl. A47J 36/06

(52) U.S. Cl. 220/201

(57) ABSTRACT

A lid for use with a cooking pot or pan having an upper part and a lower part fixed to each other such that the upper surface of the lower part and the lower surface of the upper part are spaced from each other except at the perimeters to define a thermal break between the upper and lower parts of the lid. The lower surface of the lower part includes a plurality of downward projections for contributing a continuous basting to food during the cooking process. A handle fixed to the upper part is thermally isolated from the pot or pan by the thermal break.

### BACKGROUND

This invention relates generally to a cooking utensil, and more particularly to a lid having self-basting features for use with a vessel such as a pot or pan.

It is generally known that, during cooking with a vessel such as a pot or pan, the use of a lid generally sealing the top opening to the vessel acts to retain the heat being applied and acts to preserve the moisture present in the vessel. Lids traditionally have been formed of a single layer of material often shaped as a smooth dome extending upwardly from a perimeter designed to engage an upper edge of the vessel.

For some time it has been known that the presence of downward protrusions from the lower surface of a lid act as condensation points for moisture vapor and, if appropriately situated, can be used to return evaporated moisture to food being cooked within the vessel. The condensation points can take the form, for example, of rings or radial vanes or nubs suitably distributed on the lower surface of the lid to return the condensate to a desired portion of the vessel. To enhance the volume of condensate formation, some lids have adopted structures intended to have a lid cooling feature.

What is needed is a lid suitable for use with cookware that provides a self-basting feature while minimizing any thermal transfer to any handle fixed to the lid.

### SUMMARY

In one embodiment, a lid for use with a cooking vessel such as a pot or pan can include an upper part and a lower part, each of the upper and lower parts having an upper surface and a lower surface, the upper and lower surfaces of each part meeting at a perimeter. A handle can be fixed to the upper surface of the upper part. A plurality of protrusions can extend away from the lower surface of the lower part to form drip points for condensing moisture vapor. The perimeters of the upper and lower parts can be fixed to each other such that the upper surface of the lower part and the lower surface of the upper part are spaced from each other except at the perimeters to define a thermal break between the upper and lower parts of the lid.

In a particular embodiment, the upper and lower parts of the lid can be formed independently of a metal having low to modest thermal conductivity such as stainless steel. The upper and lower parts of the lid are preferably fixed to each other only at the perimeter. The thermal break between the upper and lower parts of the lid can be filled with air that preferably has a low humidity content to reduce thermal exchange between the upper and lower parts of the lid.

In a preferred embodiment, the lower part of the lid can be characterized as having a diagonal vessel-edge engaging portion immediately adjacent to the lower part perimeter. The lower part of the lid can be further characterized as having an upwardly extending inverted channel portion immediately adjacent to an inner edge of the vessel-edge engaging portion. The lower part of the lid can be further characterized as having a downwardly depending central portion extending inward from the inverted channel portion to a central axis of the lower part. The plurality of protrusions can extend over the downwardly depending central portion. The plurality of protrusions can also extend over the inverted channel portion.

In a preferred embodiment, the upper part can include an upwardly curving portion immediately adjacent to the perimeter. The upper part can be further characterized as having a central depression extending from the upwardly curving portion to the central axis, the depression being shallow enough to ensure a space between the upper surface of the lower part and the lower surface of the upper part. The handle can be fixed to an outer section of the central depression so that the handle is thermally remote from any heating.

Other features of the present cooking utensil and the corresponding advantages of those features will be come apparent from the following discussion of a preferred embodiment, which is illustrated in the accompanying drawings. The components in the figures are not necessarily to scale, emphasis instead being placed upon illustrating the principles of the invention. Moreover, in the figures, like referenced numerals designate corresponding parts throughout the different views.

### BRIEF DESCRIPTION OF THE DRAWINGS

FIG. 1 is a top elevation view of a self-basting lid.

FIG. 2 is a side elevation view of the self-basting lid.

FIG. 3 is a bottom elevation view of the self-basting lid.

FIG. 4 is a section view of the self-basting lid.

### DESCRIPTION OF PREFERRED EMBODIMENTS

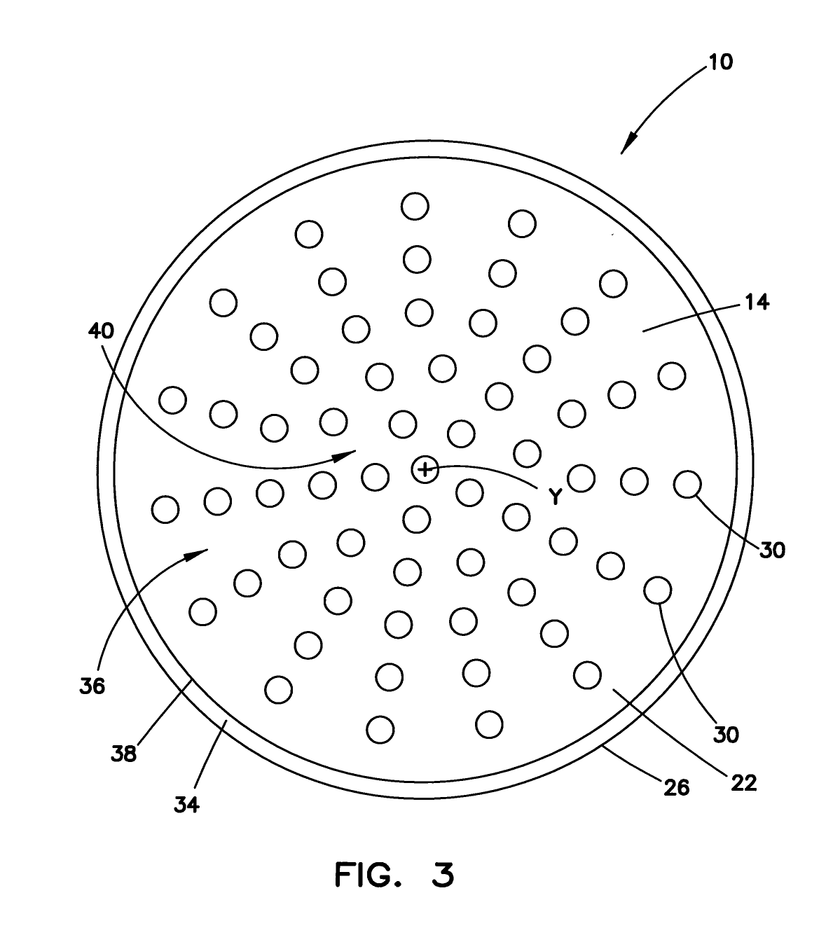

A lid 10 is shown in FIGS. 1-4 that can be used with a cooking vessel is such as a pot or pan, not illustrated. The lid 10 can include an upper part 12 and a lower part 14. The upper part 12 can have an upper or outer surface 16 and a lower or inner surface 18. The lower part 14 can have an upper or inner surface 20 and a lower or outer surface 22. The upper and lower surfaces of the upper part 12 can meet to define a perimeter 24, while the upper and lower surfaces of the lower part 14 meet to define a perimeter 26. A handle 28 can be fixed to the upper surface 16 of the upper part 12. A plurality of protrusions 30 can extend away from the lower surface 22 of the lower part 14 to form drip points for condensing moisture vapor. The perimeters 24, 26 of the upper and lower parts 12, 14 can be fixed to each other such that the upper surface 20 of the lower part 14 and the lower surface 18 of the upper part 12 are spaced from each other, except at the perimeters, to define a thermal break 32 between the upper and lower parts of the lid 10.

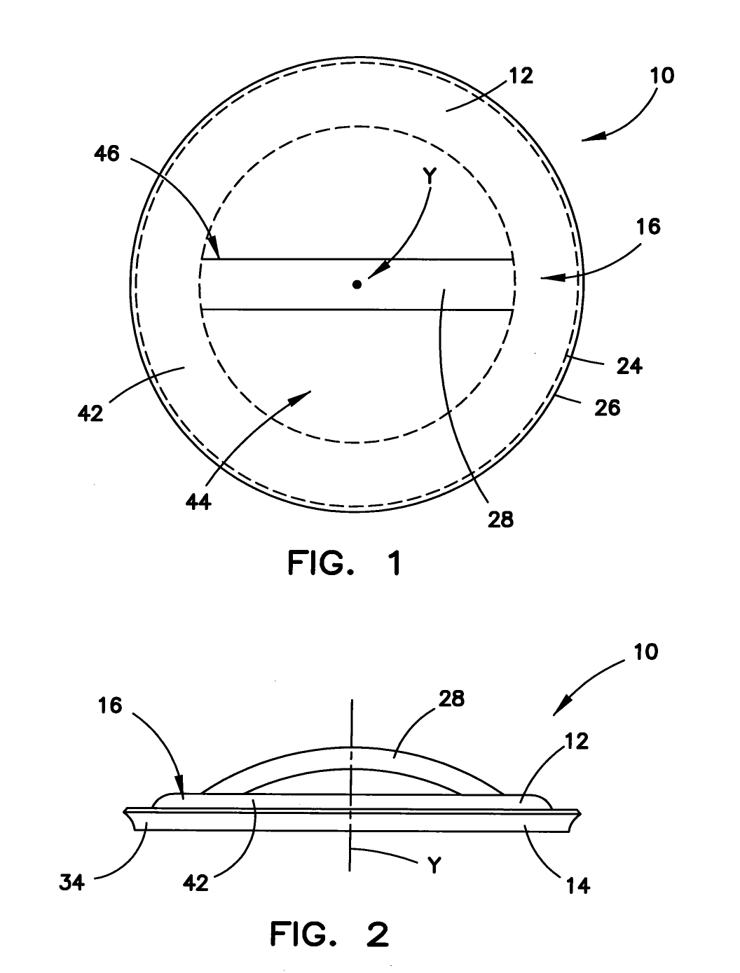

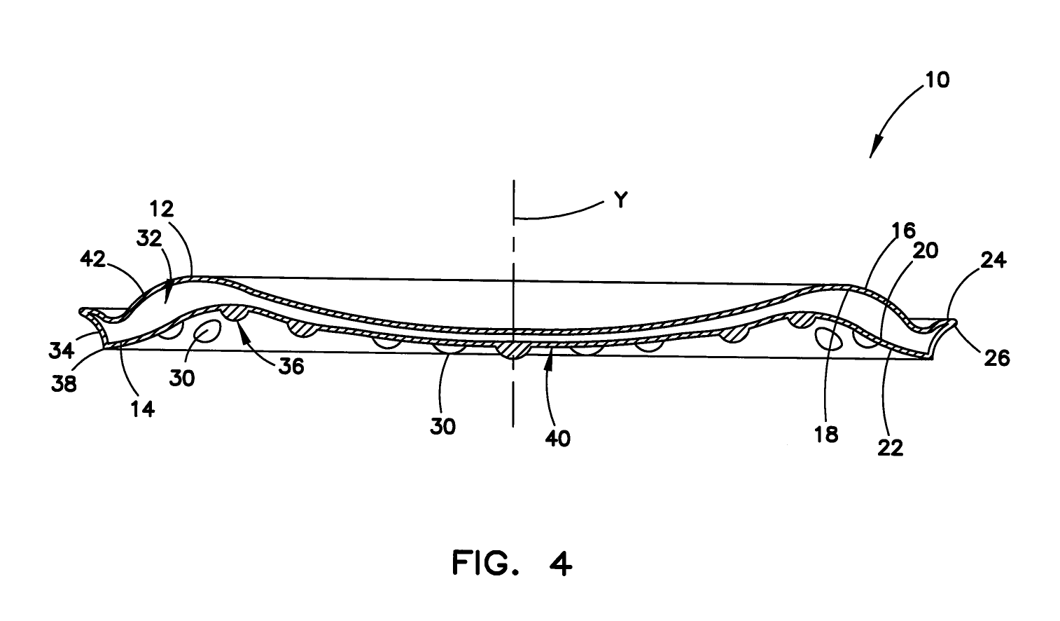

The lower part 14 of the lid 10 can be seen in FIGS. 2-4 as having a diagonal vessel-edge engaging portion 34 immediately adjacent to the lower part perimeter 26. The lower part 14 of the lid can be further seen in FIG. 4 as having an upwardly extending inverted channel portion 36 immediately adjacent to an inner edge 38 of the vessel-edge engaging portion 34. The lower part 14 of the lid can be further seen as having a downwardly depending central portion 40 extending inward from the inverted channel portion 36 to a central axis Y. The plurality of protrusions 30 can extend over the downwardly depending central portion 40. The plurality of protrusions 30 can also extend over at least a part of the inverted channel portion 36. The plurality of protrusions 30 are shown to comprise nubs or dimples, but can take the form, for example, of rings or radial vanes, suitably distributed on the lower surface 22 of the lid lower part 14 to return condensate to a desired portion of the vessel.

The upper part 12 can be seen in FIGS. 1, 2 and 4 to include an upwardly curving portion 42 immediately adjacent to the perimeter 24. The upper part 12 can be seen in FIGS. 1 and 4 to have a central depression 44 extending from the upwardly curving portion 42 to the central axis Y. The depression 44 is shallow enough to ensure a space between the upper surface 20 of the lower part 14 and the lower surface 18 of the upper part 12. The handle 28 can be fixed to an outer section 46 of the central depression 44 so that the handle is thermally remote from any heating.

The upper and lower parts 12, 14 of the lid 10 can be formed independently of a metal having low to modest thermal conductivity such as stainless steel. Other materials can be used, which can include glass, plastics, and pyro ceramics. The upper and lower parts 12, 14 of the lid can be fixed to each other, for example, by welding, spin welding, ultrasonic welding, edge wrapping and swaging, a high temperature adhesive, riveting with an intermediate gasket, and by an enveloping gasket on the outside of the perimeters 24 and 26. The thermal break 32 between the upper and lower parts of the lid 10 can be filled with air. The air filling the thermal break preferably has a low humidity content to reduce thermal exchange between the upper and lower parts of the lid 10. The humidity content should be sufficiently low as to prevent any significant expansion of the thermal break dimensions due to interior pressure increases during heating use. The humidity content should also be sufficiently low to prevent any interaction between the moisture and the materials making up the lid such as rusting.

While these features have been disclosed in connection with the illustrated preferred embodiment, other embodiments of the invention will be apparent to those skilled in the art that come within the spirit of the invention as defined in the following claims.

1. A lid for use with a cooking pot or pan, the lid comprising: an upper part and a lower part, each of the upper and lower parts having an upper surface and a lower surface, the upper and lower surfaces of each part meeting at a perimeter, a handle fixed to the upper surface of the upper part, a plurality of protrusions extending away from the lower surface of the lower part, the perimeters of the upper and lower parts being fixed to each other such that the upper surface of the lower part and the lower surface of the upper part are spaced from each other except at the perimeters to define a thermal break between the upper and lower parts of the lid.

2. The lid of claim 1, wherein the upper and lower parts of the lid comprise a metal having a low to modest thermal conductivity.

3. The lid of claim 2, wherein the metal consists essentially of stainless steel.

4. The lid of claim 1, wherein the thermal break is filled with air.

5. The lid of claim 4, wherein the air has a sufficiently low moisture content to prevent any significant thermal exchange across the thermal break.

6. The lid of claim 1, wherein the lower part comprises a diagonal vessel-edge engaging portion immediately adjacent the lower part perimeter.

7. The lid of claim 6, wherein the lower part comprises an upwardly extending inverted channel portion immediately adjacent to an inner edge of the vessel-edge engaging portion.

8. The lid of claim 7, wherein the lower part comprises a downwardly depending central portion extending inward from the inverted channel portion to a central axis of the lower part.

9. The lid of claim 8, wherein the plurality of protrusions extend over the downwardly depending central portion.

10. The lid of claim 9, wherein the plurality of protursions extend over the inverted channel portion.

11. The lid of claim 1, wherein the upper part comprises an upwardly curving portion immediately adjacent to the upper part perimeter.

12. The lid of claim 11, wherein the upper part comprises a central depression extending from the upwardly curving portion inward to a central axis of the upper part.

13. The lid of claim 12, wherein the handle is fixed to an outer section of the central depression.

14. A lid for use with a cooking pot or pan, the lid comprising: an upper part and a lower part, each of the upper and lower parts having an upper surface and a lower surface, the upper and lower surfaces of each part meeting at a perimeter, the lower part including a diagonal vessel-edge engaging portion immediately adjacent the lower part perimeter, the upper part including an upwardly curving portion immediately adjacent to the upper part perimeter, a handle fixed to the upper surface of the upper part, a plurality of protrusions extending away from the lower surface of the lower part, the perimeters of the upper and lower parts being fixed to each other such that the upper surface of the lower part and the lower surface of the upper part are spaced from each other except at the perimeters to define a thermal break containing air between the upper and lower parts of the lid.

15. The lid of claim 14, wherein the lower part comprises an upwardly extending inverted channel portion immediately adjacent to an inner edge of the vessel-edge engaging portion.

16. The lid of claim 15, wherein the lower part comprises a downwardly depending central portion extending inward from the inverted channel portion to a central axis of the lower part.

17. The lid of claim 16, wherein the plurality of protrusions extend over the downwardly depending central portion.

18. The lid of claim 17, wherein the plurality of protursions extend over the inverted channel portion.

19. The lid of claim 14, wherein the upper part comprises a central depression extending from the upwardly curving portion inward to a central axis of the upper part.

20. The lid of claim 19, wherein the handle is fixed to an outer section of the central depression.
